(19) United States
(12) Patent Application Publication
(10) Pub. No.: US 2003/0107580 A1
(43) Pub. Date: Jun. 12, 2003

(54) Dynamic mapping of texture maps onto three dimensional objects

(75) Inventors: Ren Egawa, Wayne, PA (US); Michael R. Harris, Phoenixville, PA (US)

Correspondence Address: STMICROELECTRONICS, INC., MAIL STATION 2346, 1310 ELECTRONICS DRIVE, CARROLLTON, TX, 75006, US

(73) Assignee: STMICROELECTRONICS, INC., CARROLLTON, TX

(21) Appl. No.: 10/023,377

(22) Filed: Dec. 12, 2001

(51) Int. Cl. G09G 5/00

(52) U.S. Cl. 345/582

(57) ABSTRACT

A method, system and computer readable medium for providing targeted advertising during execution of an application is described. A server system assembles an application including 3D objects and advertising texture maps directed towards a demographic. The application is then provided for download over a network to a client system, which belongs to the demographic. The client system then executes the application, which maps the texture maps onto the 3D objects during execution. The client system displays the 3D objects during execution of the application. The server system sends periodic updates consisting of texture maps to the client system. The client system maps the updated texture maps onto the 3D objects during execution.

### BACKGROUND OF THE INVENTION

1. Field of the Invention

The present invention generally relates to the field of computer graphics and, more specifically, to the field of texture mapping.

2. Description of Related Art

The video game market has enjoyed increasing success in recent years. In the year 2000, the video game market exceeded $15 billion in sales and sold over 191 million units. One aspect of the video game market that has started growing is advertising. Video game makers provide outlets for advertising in three-dimensional graphical display objects (3D objects) visible during game play. For example, in a soccer video game, the side panels on the soccer field many times include advertising logos and in a basketball video game, the player's shirts can contain ads. Advertising in a video game is beneficial because the advertisement does not break the continuity of the video game and the advertisement remains on the display for a longer period of time than a commercial. In addition, there is no loss of “eyeball” attention as game players concentrate on the display during play. Video games provide competitive and effective opportunities for advertisers.

Current techniques for allowing advertising in video games, however, do not come without their drawbacks. Often, 3D objects and the corresponding advertisements (stored as texture maps) are treated as one object. This renders the 3D object inextricable from the texture map. As a result, once a 3D object is associated with a texture map, the 3D object is stuck with that texture map for the life of the video game. This can make the video game seem monotonous and static after many plays. In addition, once the texture maps for a video game have been coded into the video game, the texture maps typically cannot be changed or renewed. This can also make the video game seem stale after many plays. In addition, current video game advertising techniques do not allow for targeted advertising to occur during game play. This is also leads to the eventual lack of variety in the video game.

Accordingly, there exists a need for a technique that effectively allows dynamic association of texture maps with 3D objects in a video game.

### SUMMARY OF THE INVENTION

A method, system and computer readable medium for providing targeted advertising during execution of an application is described. In an embodiment of the present invention, a server system assembles an application including 3D objects and advertising texture maps directed towards a demographic. The application is then provided for download over a network to a client system, which belongs to the demographic. The client system then executes the application, which maps the texture maps onto the 3D objects during execution. The client system displays the 3D objects during execution of the application.

In another embodiment of the present invention, the server system periodically provides advertising texture maps to the client system during execution of the application. The client system then maps the received texture maps onto the 3D objects during execution of the application.

In yet another embodiment of the present invention, during execution of the application, the application gathers information regarding the demographic of the client system and selects texture maps directed towards the demographic. The selected texture maps are then mapped onto the 3D objects during execution of the application.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating the overall system architecture of an embodiment of the present invention.

FIG. 2 is a block diagram illustrating the texture mapping operation, in an embodiment of the present invention.

FIG. 3 is a block diagram illustrating one example of the texture mapping operation, in an embodiment of the present invention.

FIG. 4 is a flowchart depicting the overall operation and control flow of the server side of one embodiment of the present invention.

FIG. 5 is a flowchart depicting the operation and control flow of the client side of one embodiment of the present invention.

FIG. 6 is a block diagram illustrating a set-top box performing the operations of an embodiment of the present invention.

FIG. 7 is a block diagram of an exemplary computer system useful for implementing the present invention.

### DETAILED DESCRIPTION OF PREFERRED EMBODIMENTS

### 1. Overview of the System

The present invention is described in terms of the exemplary embodiments below. This is for convenience only and is not intended to limit the application of the present invention. In fact, after reading the following description, it will be apparent to one of ordinary skill in the relevant art(s) how to implement the present invention in alternative embodiments.

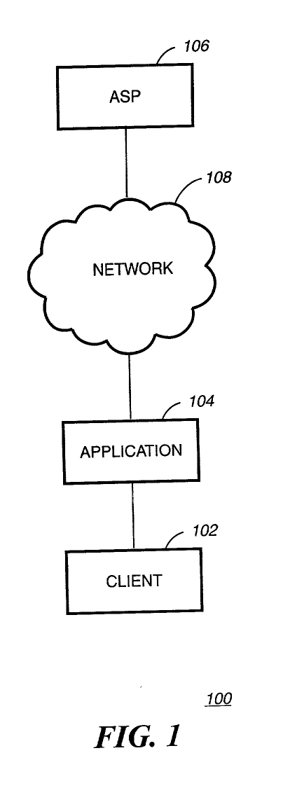

FIG. 1 is a block diagram illustrating the overall system architecture of an embodiment of the present invention. FIG. 1 is a generalized embodiment of the present invention illustrating the Application Service Provider (ASP) model of the present invention. This model represents a method by which an entity (the ASP) separate from a client provides a service to the client in exchange for a fee. The system 100 includes a client 102, a client application 104, a network 108 and an ASP 106. Client 102 is a person that is using a device such as a computer to access the services of ASP 106 via network 108.

In one embodiment of the present invention, network 108 is a circuit-switched network such as a Public Switched Telephone Network (PSTN), which is also known as the Plain Old Telephone System (POTS). In another embodiment of the present invention, network 108 is a packet-switched wide area network (WAN) such as the global Internet. Network 108 is a private WAN, a local area network (LAN), a telecommunications network or any combination of the above-mentioned networks. Network 106 is wired, wireless, broadcast or point-to-point.

In the event that network 108 is a PSTN, the device used by client 102 to access network 108 is a telephone-capable device for sending and receiving audio signals. In an embodiment of the present invention, the device is an ordinary telephone or a mobile/cell phone. In another embodiment of the present invention, the device is a personal computer (PC) (e.g., an IBM or compatible PC workstation running the Microsoft Windows 95/98/2000/NT/ME/CE/XP operating system, Macintosh computer running the Mac OS operating system, or the like), a Personal Digital Assistant (PDA) (e.g., a PalmPilot running the Palm OS operating system), a game console (e.g., a Sony Playstation 2 console or a Microsoft Xbox console) or interactive television. In the event that network 108 is a packet-switched network such as the Internet, the device is a network-capable device for sending and receiving audio signals. In this case, the device is a PC, a PDA, a game console, interactive television or any other network-capable processing device able to communicate via the network 108.

Application 104 encompasses the substantive operations of the present invention. Application 104 is implemented in hardware, software or any combination of the two. Application 104 is preferably a computer readable medium, e.g., software, that is executed using the device of client 102 as described above. Application 104 is any commercially available end-user application such as a video game, a personal finance application, a word processing application, a spreadsheet application a graphical design application or a 3D art utility application. Preferably, application 104 is a video game.

ASP 106 is an entity that provides services to client 102. Specifically, ASP 106 provides application 104 and/or texture maps to client 102 via network 108. The services provided to client 102 by ASP 106 are described in greater detail below. ASP 106 is a web site, a web page, an FTP site, a gopher site, a dial up facility, or a dial up database capable of providing the required services to client 102. ASP 106 is implemented in hardware, software or any combination of the two.

In one embodiment of the present invention, ASP 106 is one or more SUN Ultra workstations running the SunOS operating system. In another embodiment of the present invention, ASP 106 is one or more IBM or compatible PC workstations with Intel Pentium III processors running either the Windows NT/2000 operating system or the BSD Unix operating system. ASP 106 is connected to network 108, which serves as the communications medium between ASP 108 and its clients (e.g., client 102). While only one client 102 and only one application 104 are shown in FIG. 1 for ease of explanation, the system 100 may support any number of clients 102 and applications 104.

In some embodiments of the present invention, there is no network 108. This scenario represents the non-network model of the present invention. In such embodiments, the device of client 102 interacts directly with ASP 106 without traversing a network.

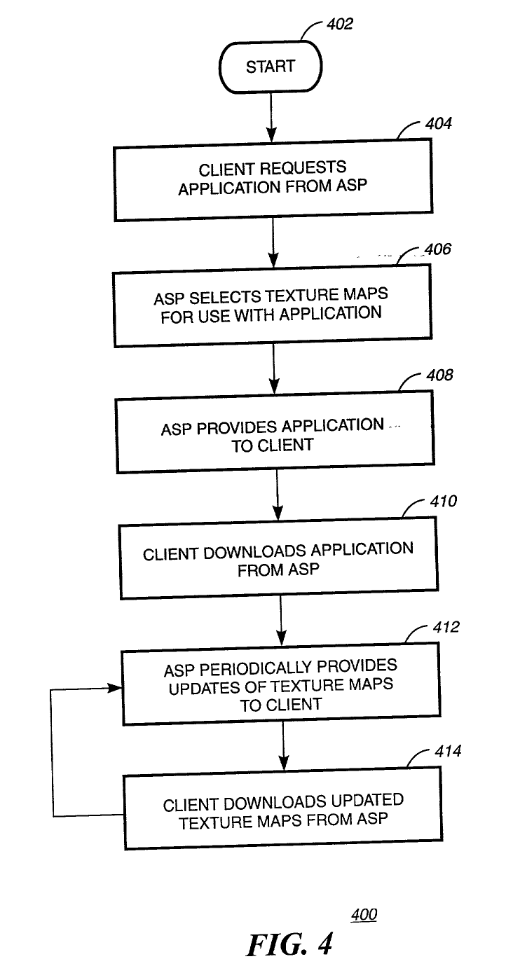

More detailed descriptions of system 100 components, as well as their functionality and inter-functionality with other system 100 components, are provided below. The operation of the system of FIG. 1 according to one embodiment of the present invention is shown in the flowchart of FIG. 4.

### 2. Texture Mapping

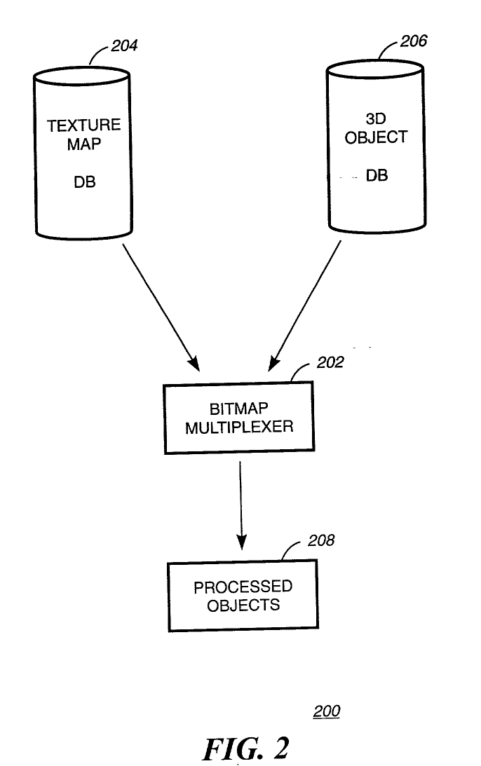

FIG. 2 is a block diagram 200 illustrating the texture mapping operation, in an embodiment of the present invention. FIG. 2 shows the texture mapping operation as it is performed by application 104 during execution. Diagram 200 shows a texture map database 204 for storing texture maps, a 3D object database 206 for storing 3D objects, a bitmap multiplexer 202 for performing the texture mapping operation and the resulting 3D objects 208.

As is commonly known in the computer graphics art, three-dimensional graphical display objects (3D objects) are used to represent real-life objects in computer applications such as video games. 3D objects are simple objects such as cubes or spheres but also more complex objects such as a toroid or a human face. A texture map is typically a two-dimensional picture or pattern that is mapped onto the surface of a 3D object. A texture map is represented by a bitmap or other picture file formats such as JPEG, GIF or TIFF. In order to add to the realism or aesthetic of a 3D object, texture maps are often mapped onto the 3D object. This process is called “texture mapping,” “mapping,” or “applying.”

Various methods of texture mapping are used. Such methods include planar projection, box projection, cylindrical projection, spherical projection and shrink projection. One example of a texture map that is mapped onto a 3D object is a two-dimentional map of the Earth that is texture mapped onto a sphere using a cylindrical projection. This results in a globe representing the Earth. Another example is a photo of a person's face that is texture mapped onto a 3D representation of a human face using planar projection. This results in an avatar representing the person.

Diagram 200 shows how application 104, preferably a video game, maps a texture map onto a 3D object. Diagram 200 shows that the bitmap multiplexer 202 selects a 3D object from 3D object database 206, selects a texture map from texture map database 204 and maps the selected texture map onto the selected 3D object. The resulting object is the processed object 208. The bitmap multiplexer 202 selects a 3D object from 3D object database 206 as it arises in the normal course of execution of the application. In the example of a video game application, as certain 3D objects are encountered during the execution of the video game and these 3D objects must be displayed, the appropriate 3D objects are selected from the 3D object database 206 for processing before being displayed. The bitmap multiplexer 202 selects a texture map from texture map database 206 as 3D objects are selected for display. When a 3D object is selected for display, the texture map corresponding to the 3D object is selected for mapping onto the 3D object.

Bitmap multiplexer 202 determines which texture map corresponds to each 3D object is a variety of ways. In one embodiment of the present invention, the bitmap multiplexer 202 uses a list that defines a predefined texture map for each 3D object. In another embodiment of the present invention, bitmap multiplexer 202 uses an algorithm that defines the correspondence between texture maps and 3D objects. In yet another embodiment of the present invention, bitmap multiplexer 202 determines which texture map corresponds to each 3D object using any routine that is deemed appropriate by one of ordinary skill in the art.

The correspondence between texture maps and 3D objects is defined at any of several points in time. In one embodiment of the present invention, the correspondence is defined before client 102 acquires application 104. In this case, the correspondence is defined by ASP 106 or any other entity from which client 102 acquired application 104. In another embodiment of the present invention, client 102 defines the correspondence during execution of application 104. In this case, the correspondence is defined during execution according to an algorithm or a running routine. This function of the present invention is described in greater detail below.

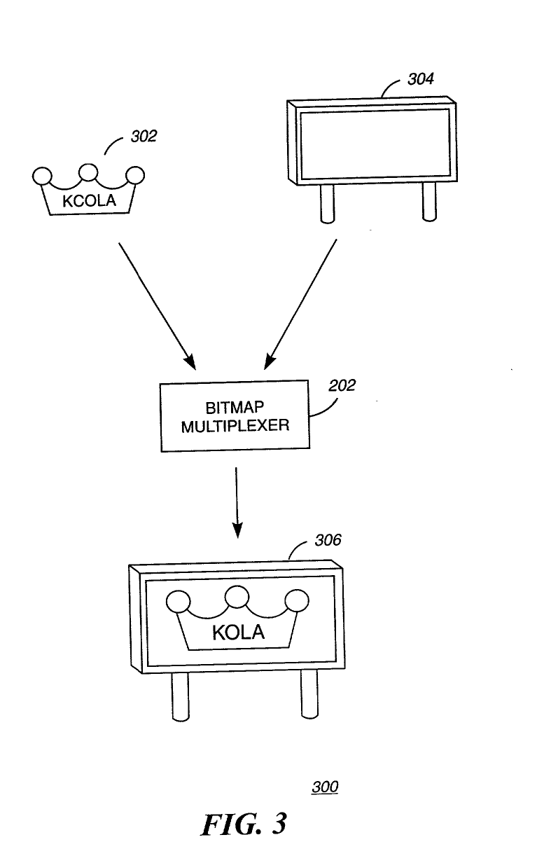

FIG. 3 is a block diagram 300 illustrating one example of the texture mapping operation, in an embodiment of the present invention. Diagram 300 shows one instance of the texture mapping operation as it is performed by application 104 during execution. Diagram 300 shows a texture map 302, a 3D object 304, the bitmap multiplexer 202 and the processed object 306.

Diagram 300 shows the texture mapping operation as it occurs during execution of application 104—a race-driving video game in this example. As the scenes in the video game change, application 104 selects the appropriate 3D object for display. In this case, the driver encounters a billboard—3D object 304. Subsequently, bitmap multiplexer 202 selects 3D object 304 for display. Then, bitmap multiplexer 202 proceeds to use a list that defines which texture map corresponds to 3D object 304. Bitmap multiplexer 202 determines that texture map 302 corresponds to 3D object 304 and proceeds to selects texture map 304. Lastly, bitmap multiplexer 202 maps texture map 302 onto 3D object 304 resulting in processed object 306.

Diagram 300 shows 3D object 304 as a billboard. In an embodiment of the present invention, 3D object 304 is a playing field, playing field side panel, a wall, a player's shirt, a player's helmet, a player's vehicle, a player's weapon or a building. Diagram 300 also shows texture map 302 as a logo representing an advertiser. In an embodiment of the present invention, texture map 302 is text representing an advertiser, an image of a person representing an advertiser or any other image representing an advertiser.

### 3. General Operation of the System

FIG. 4 is a flowchart depicting the overall operation and control flow 400 of the server side of one embodiment of the present invention. Flow 400 describes the functions performed by ASP 106 in the present invention (See FIG. 1). As described above, ASP 106 is a web site, FTP site or other location for providing a service to client 102. In an example, ASP 106 is a web site that provides video games for download by client. Control flow 400 begins with step 402 and flows directly to step 404.

In step 404, ASP 106 receives a request for application 104 from client 102. The request is a Hyper Text Transfer Protocol (HTTP) request, an FTP request or any other request adhering to a protocol for exchanging information. ASP 106 subsequently prepares to address the request. In the ongoing example, ASP 106 receives, via an Internet connection, an HTTP request for download of a race-driving video game.

In step 406, ASP 106 selects the texture maps that will be associated with application 104. Referring to FIG. 2, ASP 106 populates texture map database 204. ASP 106 determines which texture maps to enter into texture map database 204 using techniques such as targeted advertising. The techniques used by ASP 106 in this manner are described in greater detail below. In an alternative to populating texture map database 204, ASP 106 modifies the method by which bitmap multiplexer 202 determines the correspondence between texture maps and 3D objects. Thus, in this alternative, ASP 106 modifies the list, the algorithm or the routine used by bitmap multiplexer 202 to determine the correspondence between texture maps and 3D objects. ASP 106 uses techniques such as targeted advertising techniques to modify the correspondence between texture maps and 3D objects. The techniques used by ASP 106 in this manner are described in greater detail below.

In the ongoing example, ASP 106 selects a set of bitmaps for population of texture map database 204, which comprises the race-driving video game desired for download by client 102. The selected set of bitmaps are advertisements for products that are targeted toward the demographic of the client 102. ASP 106 determines the demographic of the client 102 from information such as the client's location (zip code, street address, IP address), age, income, etc. The bitmaps are logos and text representing advertisers and are intended for mapping onto 3D objects such as billboards, walls and the bodies of cars in the video game. The manner in which ASP 106 determines the demographic of client 102 and selects bitmaps targeted toward the demographic of client 102 is described in greater detail below.

In step 408, ASP 106 provides the application 104 to client 102. In an embodiment of the present invention, ASP 106 posts the application 104 on a web site, FTP site or other location accessible for download to client 102. In step 410, client 102 downloads application 104 from ASP 106. In the ongoing example, ASP 106 posts the desired race driving video game to a web page and client 102 downloads the video game, via an Internet connection, using a standard web browser download utility.

In step 412, ASP 106 periodically provides updated texture maps to client 102. The period is one month, one week, one day or one hour. In an embodiment of the present invention, ASP 106 posts the application 104 on a web site, FTP site or other location accessible for download to client 102. In the ongoing example, ASP 106 periodically posts onto a web site a new set of bitmaps. The updated bitmaps reflect new advertisers or new images targeted toward the demographic of client 102.

In step 414, client 102 downloads the updated texture maps from ASP 106. Client 102 later uses the updated texture maps for mapping onto 3D objects. In the ongoing example, client 102 downloads the updated bitmaps via the Internet and uses the bitmaps for mapping onto 3D objects such as the bodies of cars. Control flows back to step 412. In this way, texture maps are periodically provided to client 102 and client 102 periodically downloads them.

Control flow 400 is given only by way of example. The sequence of steps is exemplary and is not necessary for proper operation of the present invention. The steps of control flow can be rearranged to perform the same function. For example, in one embodiment of the present invention, step 406 occurs after step 404. In an embodiment of the present invention, steps 404 to 410 are optional. In this embodiment, client 102 is already in possession of application 104 and simply receives updates to the texture maps (in steps 412 to 414).

One advantage of control flow 400 is the quick and easy selection of texture maps in step 406 by ASP 106. Texture maps are selected and entered into texture map database 204 in a short period of time. Texture map database is a database file, a dynamic linked list, a list of files, a directory of files or any other collection of data that is amendable to quick insertion of a record. This allows ASP 106 to rapidly insert into application 104 texture maps that are targeted towards client 102. Another advantage of control flow 400 is the ability by ASP 106 to update texture maps in step 412. This allows ASP 106 to quickly provide updates of advertiser bitmaps to client 102 by simply sending the bitmaps to client 102 instead of entire applications or executable files. This also provides an application 104 that appears to be dynamic and new to client 102.

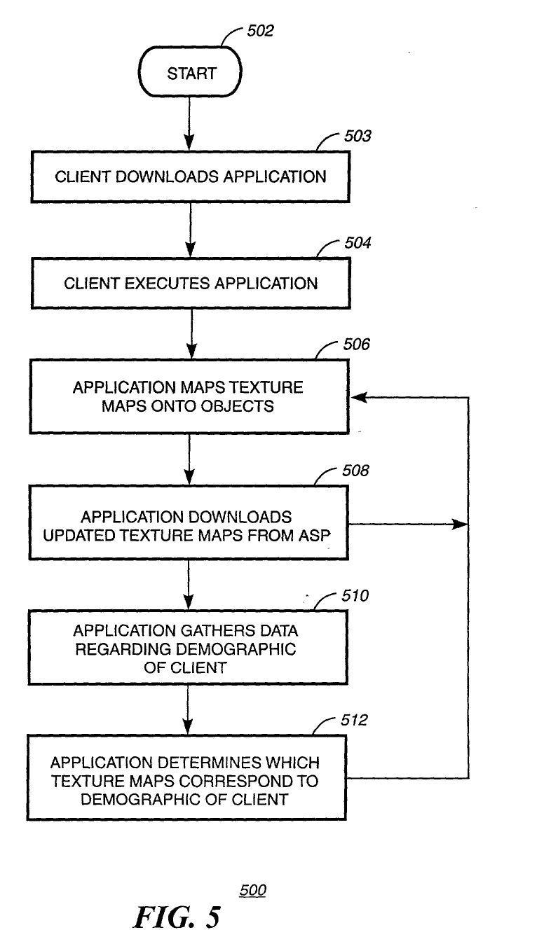

FIG. 5 is a flowchart depicting the overall operation and control flow 500 of the client side of one embodiment of the present invention. Flow 500 describes the functions performed by client 102 and application 104 (see FIG. 1) in the present invention. As described above, client 102 is a person using a device such as a computer for executing application 104. In an example, client 102 is a person using a PC to download and play a race-driving video game. Control flow 500 begins with step 502 and flows directly to step 504.

In step 503, client 102 downloads application 104. This step is analogous to step 410 of control flow 400 above. In an embodiment of the present invention, client 102 downloads the application 104 from a web site, FTP site or other location accessible for download to client 102. In the ongoing example, client 102 downloads, via an Internet connection, a race-driving video game from a video game web site using a standard web browser download utility. In step 504, client 102 executes application 104. In the ongoing example, client 102 starts the race-driving video game.

In step 506, application 104 maps onto each 3D object the corresponding texture map. Texture maps and 3D objects are provided with application 104 in texture map database 204 and 3D object database 206, respectively. In the ongoing example, as 3D objects such as cars and billboards are encountered in the race-driving video game, the appropriate 3D objects and the corresponding bitmaps are retrieved from the 3D object database 206 and the texture map database 204, respectively. Subsequently, the race-driving video game maps onto each 3D object the corresponding bitmap. The bitmaps in texture map database 204 are logos, text or human faces representing advertisers.

In step 508, application 104 downloads updated texture maps for entry into texture map database 204. This step is analogous to step 414 of control flow 400 above. In the ongoing example, the race-driving video game downloads via an Internet connection updated bitmaps. The updated bitmaps are posted to a web site for download by the race-driving video game. The updated bitmaps reflect new advertisers or new images targeted toward the demographic of client 102. In an embodiment of the present invention, steps 510 and 512 are optional. That is, in this embodiment, application 104 does not perform any targeted advertising techniques. In this embodiment, control flows directly from step 508 back to step 506. In this way, texture maps are periodically downloaded by application 104 and used for mapping onto 3D objects.

In step 510, application 104 gathers information regarding the demographic of client 102. The manner in which application 104 gathers demographic information regarding client 102 is described in greater detail below. In the ongoing example, the race-driving video game collects information such as the cars chosen by the user in the race-driving game, the average play session time of the user and the total play time of the user. For example, the race-driving video game gathers that the user often chooses a Ford model truck in the video game.

In step 512, application 104 uses targeted advertising techniques to determine which texture maps to use during execution. In this step, application 104 uses the demographic information pertaining to client 102 to determine which texture maps to target towards client 102. The manner in which application 104 determines which texture maps to target towards client 102 is described in greater detail below. In the ongoing example, the race-driving video game uses the fact that the user often chooses a Ford model truck in the video game to target Ford advertisements toward the user. Control flows back to step 506 after this step. In this way, texture maps are periodically downloaded by application 104 and used for mapping onto 3D objects.

Control flow 500 is given only by way of example. The sequence of steps is exemplary and is not necessary for proper operation of the present invention. The steps of control flow can be rearranged to perform the same function. In an embodiment of the present invention, step 508 is optional. In this embodiment, application 104 does not periodically download updated texture maps from ASP 106.

One advantage of control flow 500 is the customization of application 104 that results from the gathering of demographic information from client 102. As application 104 targets advertising texture maps to client 102 based on demographic information, client 102 is provided with advertising that is directed towards his likes and spending habits. This provides an application 104 that is user-friendly and free of irrelevant advertising.

### 4. Targeted Advertising

In an embodiment of the present invention, targeted advertising is performed by ASP 106, application 104 or any combination of the two. Targeted advertising involves directing advertising towards certain groups of people. Typically, targeted advertising techniques involve the gathering of personal or demographic information to determine which groups of people should receive certain advertising. For the purposes of targeted advertising, demographic information is any information pertaining to the spending habits of a person or a group of people. Examples of demographic information are: location, income, nationality, age, sex, occupation, marital status, home ownership/rental status, type of car owned, type of computer owned, web sites visited, past spending habits and hobbies.

One example of using demographic information to target advertising is the targeting of luxury car ads towards people who have a large amount of disposable income. Another example of using demographic information to target advertising is the targeting of local business ads towards people living in that locality. Yet another example of using demographic information to target advertising is to target ads for children's toys towards children in relevant age groups.

Personal or demographic information, for use in targeted advertising, is gathered in a variety of ways in the present invention. In one embodiment of the present invention, demographic information is gathered by ASP 106 in step 404 of control flow 400 (when client 102 requests application 104 for download). Demographic information is gathered from client 102 at this juncture by prompting the client 102 for the desired information. For example, ASP 106 asks client 102 fill out an online form before client 102 proceeds to download application 104. Alternatively, ASP 106 receives desired information from client 102 in a cookie or in a Microsoft Wallet transaction.

In another embodiment of the present invention, demographic information is gathered by application 104 in step 510 of control flow 500. Demographic information is gathered from client 102 at this juncture by prompting the client 102 for the desired information. For example, application 104 asks client 102 fill out a form before client 102 proceeds to execute application 104. Alternatively, application 104 gathers desired information from client 102 by reading certain files or directories on the computer of client 102 such as a Microsoft Wallet file, a cookie file, a web browser cache directory or a web browser history file. In another alternative, application 104 gathers desired information from client 102 in the course of execution of application 104. For example, application 104 collects information such as the objects chosen by the user during execution of the application 104, the average session time of the user on the application 104 and the total session time of the user on the application 104.

In one embodiment of the present invention, targeted advertising techniques are used by ASP 106 in step 406 of control flow 400 (i.e., when selecting the texture maps for entry into texture map database 204 or when defining the correspondence between 3D objects and texture maps). Based on demographic information gathered from client 102, ASP 106 determines which texture maps will be viewed by the user during execution of the application 104. In another embodiment of the present invention, targeted advertising techniques are used by application 104 in step 512 of control flow 500 (i.e., when defining the correspondence between 3D objects and texture maps). Based on demographic information gathered from client 102, application 104 determines which texture maps will be viewed by the user during execution of the application 104.

### 5. Set-Top Box

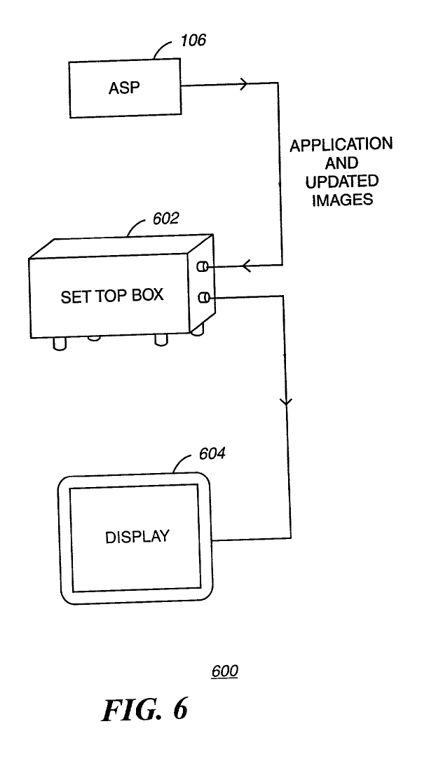

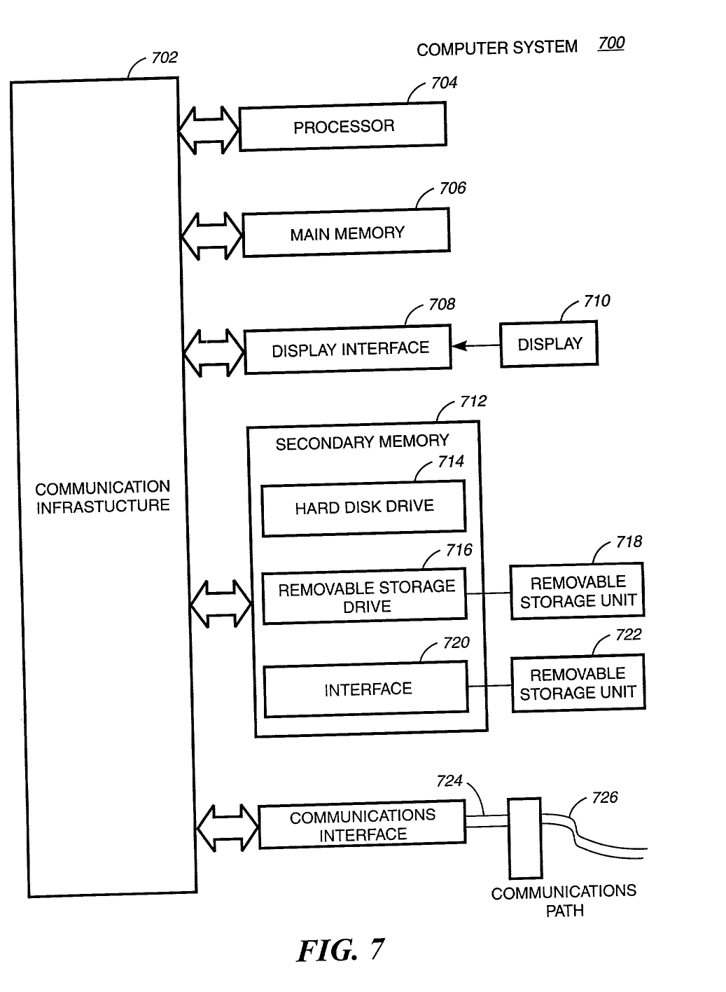

FIG. 6 is a block diagram 600 illustrating a set-top box performing the operations of an embodiment of the present invention. Diagram 600 is an exemplary embodiment of client 102 and application 104, as shown in system 100. Diagram 600 shows ASP 106, a set-top box 602 and a display 602. ASP 106 in diagram 600 performs all of the functions described for ASP 106 above. Set-top box 602 performs all of the functions described for client 102 and application 104 above. Thus, set-top box 602 preferably comprises a computer system 700 as described in FIG. 7. Display 604 is a standard display unit such as a computer CRT.

Set-top box 602 is connected to ASP 106 via a circuit switched network such as the PSTN or a packet switched network such as a private LAN or a public WAN. Set-top box 602 receives application 104 and updated bitmaps from ASP 106 via the connection to ASP 106. The received data is then used to execute application 104. During execution of application 104, information, such as images from a video game, are displayed on display 604. Display information is transmitted to display 604 from set-top box 602 via the connection to display 604.

### 6. Exemplary Implementations

The present invention (i.e., system 100, block diagrams 200, 300, 600, flows 400, 500 or any part thereof) is implemented using hardware, software or a combination thereof and is implemented in one or more computer systems or other processing systems. An example of a computer system 700 is shown in FIG. 7. The computer system 700 represents any single or multi-processor computer. In conjunction, single-threaded and multi-threaded applications are used. Unified or distributed memory systems are used.

In one example, the present invention is implemented in a multi-platform (platform independent) programming language such as Java, programming language/structured query language (PL/SQL), hyper-text mark-up language (HTML), practical extraction report language (PERL), Flash programming language, common gateway interface/structured query language (CGI/SQL) or the like. Java-enabled and JavaScript-enabled browsers are used, such as, Netscape, HotJava, and Microsoft Explorer browsers. Active content web pages can be used. Such active content web pages include Java applets or ActiveX controls, or any other active content technology developed now or in the future. The present invention, however, is not intended to be limited to Java, JavaScript, or their enabled browsers, and are implemented in any programming language and browser, developed now or in the future, as would be apparent to a person skilled in the relevant art(s) given this description.

In another example, the present invention is implemented using a high-level programming language (e.g., C++) and applications written for the Microsoft Windows NT or SUN OS environments. It will be apparent to persons skilled in the relevant art(s) how to implement the invention in alternative embodiments from the teachings herein.

Computer system 700 includes one or more processors, such as processor 704. One or more processors 704 execute software implementing the routines of the invention, described above. Each processor 704 is connected to a communication infrastructure 702 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 700 includes a display interface 708 that forwards graphics, text, and other data from the communication infrastructure 702 (or from a frame buffer not shown) for display on the display unit 710.

Computer system 700 also includes a main memory 706, preferably random access memory (RAM), and also includes a secondary memory 712. The secondary memory 712 includes, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a well known manner. Removable storage unit 718 represents a floppy disk, magnetic tape, optical disk, etc., which is read by and written to by removable storage drive 716. As will be appreciated, the removable storage unit 718 includes a computer usable storage medium having stored therein computer software and/or data.

In alternative embodiments, secondary memory 712 includes other similar means for allowing computer programs or other instructions to be loaded into computer system 700. Such means include, for example, a removable storage unit 722 and an interface 720. Examples include a program cartridge and cartridge interface (such as that found in video game console devices), a removable memory chip (such as an EPROM, or PROM) and associated socket, and other removable storage units 722 and interfaces 720 which allow software and data to be transferred from the removable storage unit 722 to computer system 700.

Computer system 700 also includes a communications interface 724. Communications interface 724 allows software and data to be transferred between computer system 700 and external devices via communications path 726. Examples of communications interface 724 include a modem, a network interface (such as Ethernet card), a communications port, interfaces described above, etc. Software and data transferred via communications interface 724 are in the form of signals which are electronic, electromagnetic, optical or other signals capable of being received by communications interface 724, via communications path 726. Note that communications interface 724 provides a means by which computer system 700 interfaces to a network such as the Internet.

The present invention is implemented using software running (that is, executing) in an environment similar to that described above. In this document, the term “computer program product” is used to generally refer to removable storage unit 718, a hard disk installed in hard disk drive 714, or a carrier wave carrying software over a communication path 726 (wireless link or cable) to communication interface 724. A computer useable medium includes magnetic media, optical media, or other recordable media, or media that transmits a carrier wave or other signal. These computer program products are means for providing software to computer system 700.

Computer programs (also called computer control logic) are stored in main memory 706 and/or secondary memory 712. Computer programs are also received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

The present invention is implemented as control logic in software, firmware, hardware or any combination thereof. In an embodiment where the invention is implemented using software, the software is stored in a computer program product and loaded into computer system 700 using removable storage drive 706, hard disk drive 714, or interface 720. Alternatively, the computer program product is downloaded to computer system 700 over communications path 726. The control logic (software), when executed by the one or more processors 704, causes the processor(s) 704 to perform functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s) from the teachings herein.

### 7. CONCLUSION

While various embodiments of the present invention have been described above, it should be understood that they have been presented by way of example, and not limitation. It will be apparent to persons skilled in the relevant art(s) that various changes in form and detail are made therein without departing from the spirit and scope of the invention. Thus the present invention should not be limited by any of the above-described exemplary embodiments, but should be defined only in accordance with the following claims and their equivalents.

What is claimed is:

1. A method for providing targeted advertising during execution of an application for display on a client system, the method on a server system, comprising the steps of:
gathering a plurality of advertising texture maps directed towards a demographic;
assembling an application including a plurality of 3D objects and the plurality of advertising texture maps, wherein the plurality of advertising texture maps are mapped onto the plurality of 3D objects during execution of the application; and
providing the application to a client system over a network, wherein the client system is a member of the demographic;
wherein the client system displays the plurality of advertising texture maps mapped onto the plurality of 3D objects during execution of the application.

2. The method of claim 1, wherein the providing step comprises:
providing the application for download by a client system over a network, wherein the client system is associated with the demographic.

3. The method of claim 2, wherein the network comprises any one of:
a local area network;
a wide area network; and
a circuit switched network.

4. The method of claim 1, wherein an advertising texture map comprises any one of:
a bitmap file;
a JPEG file;
a TIFF file; and
a GIF file.

5. The method of claim 4, wherein the advertising texture map further comprises any one of:
a logo representing the advertiser;
text representing the advertiser;
a person representing the advertiser; and
an image representing the advertiser.

6. The method of claim 1, further comprising the step of:
periodically providing to the client system over the network a plurality of advertising texture maps directed towards the demographic of the client system, wherein the plurality of advertising texture maps are mapped onto the plurality of 3D objects during execution of the application.

7. A method for providing targeted advertising to a client system, the method on the client system, comprising the steps of:
executing an application that presents a plurality of 3D objects and a plurality of advertising texture maps;
periodically receiving from a third party over a network a plurality of advertising texture maps directed towards a demographic of the client system;
mapping the plurality of advertising texture maps onto the plurality of 3D objects during execution of the application;
wherein the client system displays the plurality of advertising texture maps mapped onto the plurality of 3D objects during execution of the application.

8. The method of claim 7, wherein the network comprises any one of:
a local area network;
a wide area network; and
a circuit switched network.

9. The method of claim 7, wherein an advertising texture map comprises any one of:
a bitmap file;
a JPEG file;
a TIFF file; and
a GIF file.

10. The method of claim 9, wherein an advertising texture map further comprises any one of:
a logo representing the advertiser;
text representing the advertiser;
a person representing the advertiser; and
an image representing the advertiser.

11. The method of claim 7, wherein the executing step comprises:
executing an application that presents a plurality of 3D objects and a plurality of advertising texture maps directed towards a demographic of the client system.

12. The method of claim 11, further comprising a step before the receiving step of:
mapping the plurality of advertising texture maps onto the plurality of 3D objects during execution of the application.

13. The method of claim 7, further comprising the step of:
gathering information regarding the demographic of the client system;
selecting from the plurality of advertising texture maps a plurality of advertising texture maps determined to correspond to the demographic of the client system; and
mapping the selected plurality of advertising texture maps onto the plurality of 3D objects during execution of the application.

14. The method of claim 7, wherein the step of mapping includes:
mapping the plurality of advertising texture maps onto the plurality of 3D objects during execution of the application, wherein any one of the following texture mapping methods are used:
planar projection;
box projection;
cylindrical projection;
spherical projection; and
shrink projection.

15. A computer readable medium including computer instructions for providing targeted advertising to a client system, the computer readable medium on the client system, the computer instructions comprising instructions for:
periodically receiving from a third party over a network a plurality of advertising texture maps directed towards a demographic of the client system;
mapping the plurality of advertising texture maps onto the plurality of 3D objects during execution of the application;
wherein the client system displays the plurality of advertising texture maps mapped onto the plurality of 3D objects during execution of the application.

16. The computer readable medium of claim 15, wherein the network comprises any one of:
a local area network;
a wide area network; and
a circuit switched network.

17. The computer readable medium of claim 15, wherein an advertising texture map comprises any one of:
a bitmap file;
a JPEG file;
a TIFF file; and
a GIF file.

18. The computer readable medium of claim 17, wherein an advertising texture map further comprises any one of:
a logo representing the advertiser;
text representing the advertiser;
a person representing the advertiser; and
an image representing the advertiser.

19. The computer readable medium of claim 15, wherein the executing step comprises:
executing an application that presents a plurality of 3D objects and a plurality of advertising texture maps directed towards a demographic of the client system.

20. The computer readable medium of claim 19, further comprising a step before the receiving step of:
mapping the plurality of advertising texture maps onto the plurality of 3D objects during execution of the application.

21. The computer readable medium of claim 15, further comprising the step of:
gathering information regarding the demographic of the client system;
selecting from the plurality of advertising texture maps a plurality of advertising texture maps determined to correspond to the demographic of the client system; and
mapping the selected plurality of advertising texture maps onto the plurality of 3D objects during execution of the application.

22. The computer readable medium of claim 7, wherein the step of mapping includes:
mapping the plurality of advertising texture maps onto the plurality of 3D objects during execution of the application, wherein any one of the following texture mapping methods are used:
planar projection;
box projection;
cylindrical projection;
spherical projection; and
shrink projection.

23. A method for providing targeted advertising during execution of an application for display on a client system, the method on a server system, comprising the steps of:
gathering a plurality of advertising texture maps directed towards a demographic;
assembling the plurality of advertising texture maps, wherein the plurality of advertising texture maps are mapped onto a plurality of 3D objects during execution of an application, the plurality of 3D objects and the application on a client system; and
providing the plurality of 3D objects to the client system over a network, wherein the client system is a member of the demographic;
wherein the client system displays the plurality of advertising texture maps mapped onto the plurality of 3D objects during execution of the application.

24. A set-top box for providing targeted advertising to a client system, comprising:
an application that presents a plurality of 3D objects and a plurality of advertising texture maps, wherein the advertising texture maps are directed towards a demographic of the client system and wherein the plurality of advertising texture maps are mapped onto the plurality of 3D objects during execution of the application; and
a network connection to a third party, wherein advertising texture maps directed towards the demographic of the client system are periodically received from the third party via the connection and wherein the plurality of advertising texture maps are mapped onto the plurality of 3D objects during execution of the application.
